(19) United States
(12) Patent Application Publication
(10) Pub. No.: US 2024/0314591 A1
(43) Pub. Date: Sep. 19, 2024

(54) MODEL CONTROL AND MANAGEMENT FOR WIRELESS COMMUNICATIONS

(71) Applicant: ZTE Corporation, Shenzhen (CN)

(72) Inventors: Guozeng ZHENG, Shenzhen (CN); Zhaohua LU, Shenzhen (CN); Huahua XIAO, Shenzhen (CN); Wenfeng liu, Shenzhen (CN); Lun LI, Shenzhen (CN); Yong LI, Shenzhen (CN); Yuxin WANG, Shenzhen (CN)

(21) Appl. No.: 18/676,110

(22) Filed: May 28, 2024

Related U.S. Application Data
(63) Continuation of application No. PCT/CN2022/105764, filed on Jul. 14, 2022.

(51) Int. Cl. H04W 24/02; H04W 48/08

(52) U.S. Cl. CPC H04W 24/02; H04W 48/08

(57) ABSTRACT

Techniques are described for controlling and/or managing a model applied to a wireless communication system. An example wireless communication method comprises transmitting, by a first wireless device to a second device located in a network, a first message that requests a model information; and receiving, by the first wireless device, a second message in response to the transmitting the first message, where the second message includes a model description information that describes one or more characteristics of a model to be used by the first wireless device.

### CROSS-REFERENCE TO RELATED APPLICATION

This application is a continuation and claims priority to International Application No. PCT/CN2022/105764, filed on Jul. 14, 2022, the disclosure of which is hereby incorporated by reference herein in its entirety.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for controlling and/or managing models applied to wireless communication systems, where the models can relate to Artificial Intelligence (AI) and/or Machine Learning (ML).

A first example wireless communication method comprises transmitting, by a first wireless device to a second device located in a network, a first message that requests a model information; and receiving, by the first wireless device, a second message in response to the transmitting the first message, where the second message includes a model description information that describes one or more characteristics of a model to be used by the first wireless device.

In some embodiments, the model description information includes an identifier of the model. In some embodiments, the first message includes a field that identifies a purpose for requesting the model information. In some embodiments, the first message includes any one or more of the following information: a physical cell identifier (PCI), a transmission and reception point (TRP) identifier, an Absolute Radio Frequency Channel Number (ARFCN), a bandwidth of a cell, a sub-carrier spacing of the cell, a number of beams, directions of each of the number of beam, a number of ports, a time periodicity of a reference signal, a sub-band granularity, a first expected number of time occasions used for an input to the model, a second expected number of time occasions used for an output to the model, and/or a resource mapping pattern in frequency domain. In some embodiments, the method further comprises transmitting, by the first wireless device to the second device in the network, a third message that request a model deployment information, wherein the third message includes the identifier of the model; and receiving, in response to the transmitting the third message, a fourth message comprising the model deployment information that includes one or more values corresponding to one or more parameters to be used by the model. In some embodiments, the second message includes a model deployment information that includes one or more values corresponding to one or more parameters to be used by the model.

In some embodiments, the method further comprises receiving, by the first wireless device, a failure message in response to the transmitting the first message, wherein the failure message indicates that the second device in the network does not have the model information. In some embodiments, the first wireless device is a base station. In some embodiments, the first wireless device is a communication device. In some embodiments, the first message is transmitted by the communication device and the second message is received by the communication device using a first Non-Access Stratum (NAS) message and a second NAS message, respectively. In some embodiments, the method further comprises transmitting, by the communication device to a base station, a request to acquire assistance data; and receiving, in response to the transmitting the request, the assistance data that includes boresight directions of reference signals when the base station transmits the reference signals, and/or beam width of the reference signals when the base station transmits the reference signals.

In some embodiments, the method further comprises transmitting, by the communication device to a base station, a request to acquire any one or more configurations from the following: a physical cell identifier (PCI), a transmission and reception point (TRP) identifier, an Absolute Radio Frequency Channel Number (ARFCN), a bandwidth of a cell, a sub-carrier spacing of the cell, a number of beams, directions of each of the number of beam, a number of ports, a time periodicity of a reference signal, a sub-band granularity, a first expected number of time occasions used for an input to the model, a second expected number of time occasions used for an output to the model, and/or a resource mapping pattern in frequency domain; and receiving, in response to the transmitting the request, the any one or more configurations included in the request.

A second example wireless communication method comprises receiving, by a second device located in a network from a first wireless device, a first message that requests a model information; and transmitting, by the second device, a second message in response to the receiving the first message, where the second message includes a model description information that describes one or more characteristics of a model to be used by the first wireless device.

In some embodiments, the model description information includes an identifier of the model. In some embodiments, the first message includes a field that identifies a purpose for requesting the model information. In some embodiments, the first message includes any one or more of the following information: a physical cell identifier (PCI), a transmission and reception point (TRP) identifier, an Absolute Radio Frequency Channel Number (ARFCN), a bandwidth of a cell, a sub-carrier spacing of the cell, a number of beams, directions of each of the number of beam, a number of ports, a time periodicity of a reference signal, a sub-band granularity, a first expected number of time occasions used for an input to the model, a second expected number of time occasions used for an output to the model, and/or a resource mapping pattern in frequency domain. In some embodiments, the method further comprises receiving, by the second device in the network from the first wireless device, a third message that request a model deployment information, wherein the third message includes the identifier of the model; and transmitting, in response to the receiving the third message, a fourth message comprising the model deployment information that includes one or more values corresponding to one or more parameters to be used by the model.

In some embodiments, the second message includes a model deployment information that includes one or more values corresponding to one or more parameters to be used by the model. In some embodiments, the method further comprises transmitting, by the second device, a failure message in response to the receiving the first message, wherein the failure message indicates that the second device in the network does not have the model information. In some embodiments, the first wireless device is a base station. In some embodiments, the first wireless device is a communication device.

A third example wireless communication method comprises transmitting, by a base station, a system information message comprising a model information, where the model information includes a plurality of model description information associated with a corresponding plurality of models, and where each model description information describes one or more characteristics of a model to be used by a communication device.

In some embodiments, one of the plurality of model description information includes at least one identifier of one model. In some embodiments, the system information message is sent in a system information block (SIB), or in a radio resource control (RRC) message when the communication device is in a RRC connected state. In some embodiments, the system information message includes configuration of a plurality of resources to be used by the communication device, and at least one of the plurality of resources are mapped to at least one model from the plurality of models. In some embodiments, the plurality of resources includes a plurality of physical uplink control channel (PUCCH) resources or a plurality of random access channels (RACHs). In some embodiments, the method further comprises transmitting assistance data to the communication device, where the assistance data includes boresight directions of reference signals when the base station transmits the reference signals, and/or beam width of the reference signals when the base station transmits the reference signals.

In some embodiments, the at least one identifier includes any one of: a first identifier related to an encoder of the model, a second identifier related to a decoder of the model, or the first identifier and the second identifier. In some embodiments, the method further comprises receiving, by the base station from the communication device, a message that includes an identifier related to an encoder of the model that is used by the communication device.

A fourth example wireless communication method comprises receiving, by a communication device from a base station, a system information message comprising a model information, where the model information includes a plurality of model description information associated with a corresponding plurality of models, and where each model description information describes one or more characteristics of a model to be used by the communication device.

In some embodiments, one of the plurality of model description information includes at least one identifier of one model. In some embodiments, the system information message is received in a system information block (SIB), or in a radio resource control (RRC) message when the communication device is in a RRC connected state. In some embodiments, the system information message includes configuration of a plurality of resources to be used by the communication device, and at least one of the plurality of resources are mapped to at least one model from the plurality of models. In some embodiments, the plurality of resources includes a plurality of physical uplink control channel (PUCCH) resources or a plurality of random access channels (RACHs).

In some embodiments, the method further comprises receiving assistance data, where the assistance data includes boresight directions of reference signals when the base station transmits the reference signals, and/or beam width of the reference signals when the base station transmits the reference signals. In some embodiments, the at least one identifier includes any one of: a first identifier related to an encoder of the model, a second identifier related to a decoder of the model, or the first identifier and the second identifier. In some embodiments, the method further comprises transmitting, by the communication device to the base station, a message that includes an identifier related to an encoder of the model that is used by the communication device.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows a block diagram of a communication system comprising multiple communication devices.

FIG. 2 shows an example flowchart for requesting a model information.

FIG. 3 shows an example flowchart for transmitting a model information.

FIG. 4A shows another example flowchart for transmitting a model information.

FIG. 4B shows an example flowchart for receiving a model information.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

### DETAILED DESCRIPTION

### I. Introduction

Artificial Intelligence/Machine Learning has been studied and used in various fields. There are also some studies to improve the efficiency of wireless communication system, especially for physical layer. For example, the AI/ML model can be used to increase the accuracy of channel state information (CSI). In addition, AI/ML models can predict channel beam information in both spatial and time domain. Furthermore, positioning, channel estimation, power saving, and mobility management are some other use cases. However, this is no clear solutions on how to control and manage the AI models within the architecture and signaling designs of current 5G wireless communication system. This patent document proposes some technical solutions to control and manage AI/ML models applied to wireless communication systems.

To facilitate discussion, the following terminologies are given by some general descriptions:

| Terminology | Description |
|---|---|
| Data collection | A process of collecting data by the network nodes, management entity, or |
| | UE for the purpose of AI/ML model training, data analytic and inference |
| AI/ML model | A data driven algorithm that applies AI/ML techniques to generate a set of |
| | outputs based on a set of inputs. |
| AI/ML model | The data fed into an AI/ML model |
| input | |
| AI/ML model | The output of an AI/ML model |
| output | |
| AI/ML model | A process to train an AI/ML model by learning the input/output relationship |
| training | in a data driven manner and obtain the trained AI/ML model for inference |
| AI/ML | A process of using a trained AI/ML model to produce a set of outputs based |
| Inference | on a set of inputs |
| AI/ML model | A subprocess of training, to evaluate the quality of an AI/ML model using a |
| validation | dataset different from one used for model training, that helps selecting model |
| | parameters that generalize beyond the dataset used for model training. |
| AI/ML model | A subprocess of training, to evaluate the performance of a final AI/ML |
| testing | model using a dataset different from one used for model training and |
| | validation. Differently from AI/ML model validation, testing do not assume |
| | subsequent tuning of the model. |
| UE side | An AI/ML model whose inference is performed entirely at the UE |
| (AI/ML) model | |
| Network side | An AI/ML model whose inference is performed entirely at the network |
| (AI/ML) model | |
| One side | A UE side (AI/ML) model or a Network-side (AI/ML) model |
| (AI/ML) model | |
| Two side | A paired AI/ML model(s) over which joint inference is performed, where |
| (AI/ML) model | joint inference comprises AI/ML Inference whose inference is performed |
| | jointly across the UE and the network, i.e, the first part (or encoder |
| | part/generation model) of inference is firstly performed by UE and then the |
| | remaining part (or decoder part/reconstruction model) is performed by |
| | network, or vice versa. |
| Model transfer | Delivery of an AI/ML model, either of a model description information or a |
| | model deployment information |
| Model | Model transfer from the network to UE |
| download | |
| Model upload | Model transfer from UE to the network |
| Model | Delivery of a fully developed and tested model to a target UE/gNB where |
| deployment | inference is to be performed. |

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G or 5G Advance technology only, and may be used in wireless systems that implemented other protocols. In addition, AI/ML model is an exemplary scenario, where the technical solutions described in this patent document can be generalized or applicable to any model that determines a relationship between an input and an output.

### II. Example Technical Solutions

First of all, AI model information can include or can refer to AI model description information and/or AI model deployment information:
AI model description information can include information that describes characteristics of an AI model to be used, where the characteristics of an AI model included in the AI model description information may include any one or more of the following:
   Model functionality/purpose (e.g., which can be one of CSI compression, beam prediction in spatial domain or UE positioning)
   Model identifier (ID) and/or version ID
      For a two side model, the model ID may include either one of the following:
         a first ID related to an encoder of the AI model (or a generation model ID),
         a second ID related to a decoder of the AI model (or a reconstruction model ID),
         the first ID and the second ID.
      Two AI models with the same model ID may have different version IDs, which may mean at least one of the following,
         Two AI models with the same AI model structure but have different AI model parameters
         One AI model is updated/fine-tuned from another AI model, so the two AI models may have some common part of AI model structure or the two AI models may have some common part of AI model structure and AI model parameters
   Pre-processing of AI model input
      E.g., Normalization method to a data used for the AI model input
         For example, the data should be normalized to the maximum value of the data before it's fed into the AI model input.
   AI model input type
      E.g., channel measurement and/or assistance data
         For example, the channel measurement can be channel impulse response in time domain/channel frequency response in frequency domain/Reference Signal Receive Power (RSRP)
         For example, the assistance data can be the boresight directions of reference signals when gNB transmits the reference signals and/or beam width (e.g., 3 dB beam width) of reference signals when gNB transmits the reference signals.
   AI model input shape
      E.g., The number of dimensions and the size of each dimension of the data used for the AI model input
   AI model input order
      E.g., the order for different dimensions to be included in the data used for the AI model input.
      The following example explains on how to understand AI model input type, AI model input shape and AI input order:
         A data include a channel measurement (i.e., AI model input type), which has three dimensions as below (i.e., the number of dimensions and the size of each dimension). Now, the data is a three dimensional matrix. So the AI model description information should include how to construct (or order) the three dimensional matrix. One example can be: spatial domain, frequency domain and time domain correspond to first dimension, second dimension and third dimension of the data respectively (i.e., the order for different dimensions).
         The number (or size) of ports in spatial domain
         The number (or size) of frequency units in frequency domain
         The number (or size) of time occasions in time domain
      E.g., Quantization methods for the AI model input, which is to use limited bits to represent each element of the data.
   AI model output type
      E.g., UE position, different kind of measurements (e.g., RSRP, timing information) and etc.
   AI model output shape
      E.g., The number of dimensions and the size of each dimension of the AI model output
   AI model output order
      E.g., the order for different dimensions to be included in the AI model output.
   Post-processing of AI model output
      E.g., Quantization methods for the AI model output, which is to use limited bits to represent each element of the AI model output.
   AI model inference latency
      E.g., the time/latency that may take for AI model inference entity to conduct the AI model inference
   Applicable scenarios
      E.g., to indicate the AI model can only be applied to which physical cell and/or carrier frequency
AI model deployment information can include one or more values corresponding to one or more parameters to be used by an AI model. The one or more values of the AI model deployment information may be related to model structure and/or model parameters. The AI model deployment information includes any one or more of the following:
   AI model structure, which may include:
      the number of layers,
      the network of each layer (e.g., fully connected neural network or convolutional neural network)
      the number of neurons in each layer
      the activation function used in each layer
      the order of each layer
   AI model parameters (e.g., the value/weight of neurons in the AI model)
   For example, AI model deployment information may be a complied file (e.g., a runtime binary image) that can be executed by AI model inference entity (e.g., UE or network)
   In another example, AI model deployment information may be a complied file may be an interpret-able file that may be further compiled by AI model inference entity for execution, where the interpret-able file may use an unified representation format that can be interpreted by different AI model inference entities:
      AI model inference entity may update the AI model structure and/or AI model parameters of an AI model.
      AI model inference entity may receive updates on AI model structure and/or AI model parameters to a legacy AI model

In the following sections, how to conduct model control and management will be discussed and proposed according to which entity will perform the AI model inference, which includes:
Network side model
UE side model
Two side model

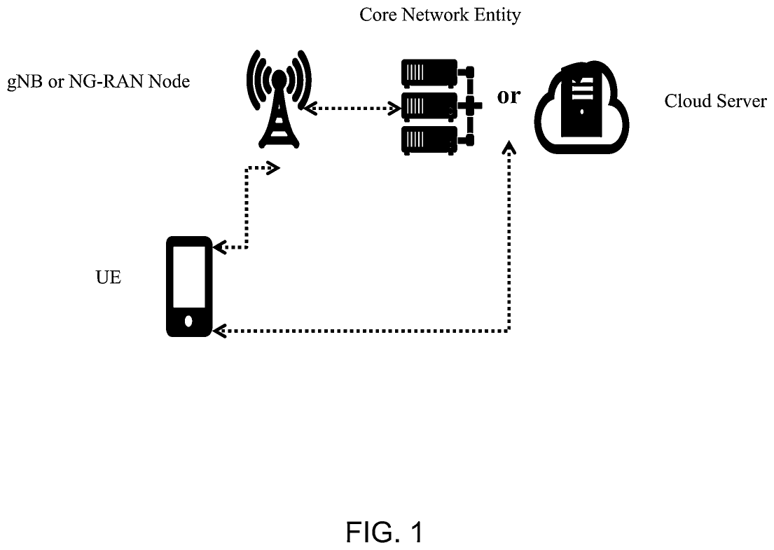

FIG. 1 shows a block diagram of a communication system comprising multiple communication devices. As shown in FIG. 1, a user equipment (UE) in communication with a base station (e.g., gNB or NG-RAN Node) and with a network device (e.g., a core network entity or a cloud server). The network side device (e.g., the core network entity) can also communicate with the base station. For ease discussion, a model control entity is defined, which is responsible for model storage, transfer of AI model information, or data collection etc. The model control entity may reside at gNB, core network entity or cloud server.

### III. Case 1: Network Side Model

In this case, gNB/NG-RAN node determines an AI model inference, and model control entity resides at a core network entity. In this case, the gNB/NG-RAN node can be considered a first wireless device, and a second device can be a device that reside in a core network entity.

gNB can send a request for AI model information to the model control entity.
In some embodiments, the request may include information that indicates the functionality/purpose of the requested AI model information. E.g., for beam prediction, CSI prediction or LoS/NLOS identification
In some embodiments, the request may further include any one or more of the following information, (which can be used for model control entity to decide what kind of AI model is required by gNB)
   Physical cell ID (PCI)
   TRP (transmission and reception point) ID
   ARFCN (Absolute Radio Frequency Channel Number)
   Bandwidth of a cell
   sub-carrier spacing of a cell
   Number of beams (e.g., number of CSI-RS resources in a CSI-RS resource set)
   Directions of each beam (e.g., the direction can be boresight direction of a beam)
   Number of ports (e.g., number of ports for a CSI-RS resource)
   Time periodicity of reference signal
   Sub-band granularity (e.g., the number of resource blocks included in a sub-band)
   Expected number of time occasions used for AI model input (which may be used for beam prediction in time domain or CSI prediction in time domain)
   Expected number of time occasions used for AI model output (which may be used for beam prediction in time domain or CSI prediction in time domain)
   Resource mapping pattern in frequency domain (e.g., to indicate which resource element will transmit reference signal, which may be used for channel estimation or CSI prediction in frequency domain)

The model control entity sends a response in response to the request from gNB
The response may indicate the failure to the request (e.g., there is no requested AI model information in model control entity)
In some embodiments, the response may only include AI model description information of AI models, wherein each AI model maybe uniquely identified by an AI model ID.
   In some embodiments, in response to the gNB receiving the AI model description information, gNB can send a request to the model control entity for AI model deployment information of an AI model, wherein the request may include an AI model ID.
In some embodiments, the response may include both AI model description information and AI deployment information of AI models, wherein each AI model maybe uniquely identified by an AI model ID.

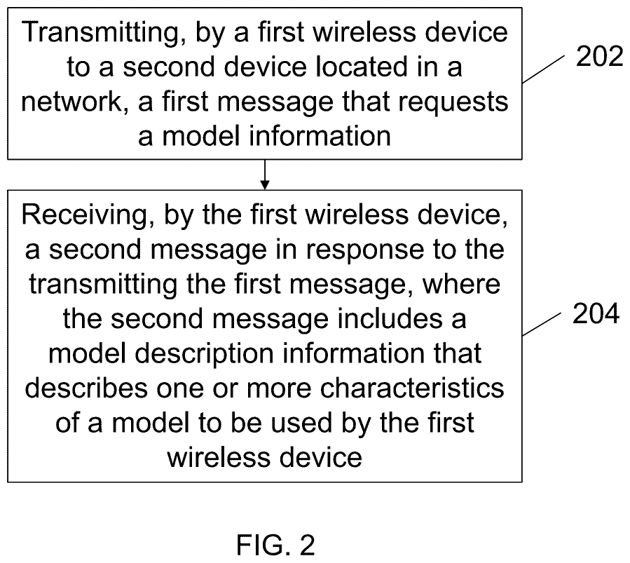

FIG. 2 shows an example flowchart for requesting a model information. Operation 202 includes transmitting, by a first wireless device to a second device located in a network, a first message that requests a model information. Operation 204 includes receiving, by the first wireless device, a second message in response to the transmitting the first message, where the second message includes a model description information that describes one or more characteristics of a model to be used by the first wireless device.

In some embodiments, the model description information includes an identifier of the model. In some embodiments, the first message includes a field that identifies a purpose for requesting the model information. In some embodiments, the first message includes any one or more of the following information: a physical cell identifier (PCI), a transmission and reception point (TRP) identifier, an Absolute Radio Frequency Channel Number (ARFCN), a bandwidth of a cell, a sub-carrier spacing of the cell, a number of beams, directions of each of the number of beam, a number of ports, a time periodicity of a reference signal, a sub-band granularity, a first expected number of time occasions used for an input to the model, a second expected number of time occasions used for an output to the model, and/or a resource mapping pattern in frequency domain. In some embodiments, the method further comprises transmitting, by the first wireless device to the second device in the network, a third message that request a model deployment information, wherein the third message includes the identifier of the model; and receiving, in response to the transmitting the third message, a fourth message comprising the model deployment information that includes one or more values corresponding to one or more parameters to be used by the model. In some embodiments, the second message includes a model deployment information that includes one or more values corresponding to one or more parameters to be used by the model.

In some embodiments, the method further comprises receiving, by the first wireless device, a failure message in response to the transmitting the first message, wherein the failure message indicates that the second device in the network does not have the model information. In some embodiments, the first wireless device is a base station. In some embodiments, the first wireless device is a communication device. In some embodiments, the first message is transmitted by the communication device and the second message is received by the communication device using a first Non-Access Stratum (NAS) message and a second NAS message, respectively. In some embodiments, the method further comprises transmitting, by the communication device to a base station, a request to acquire assistance data; and receiving, in response to the transmitting the request, the assistance data that includes boresight directions of reference signals when the base station transmits the reference signals, and/or beam width of the reference signals when the base station transmits the reference signals.

In some embodiments, the method further comprises transmitting, by the communication device to a base station, a request to acquire any one or more configurations from the following: a physical cell identifier (PCI), a transmission and reception point (TRP) identifier, an Absolute Radio Frequency Channel Number (ARFCN), a bandwidth of a cell, a sub-carrier spacing of the cell, a number of beams, directions of each of the number of beam, a number of ports, a time periodicity of a reference signal, a sub-band granularity, a first expected number of time occasions used for an input to the model, a second expected number of time occasions used for an output to the model, and/or a resource mapping pattern in frequency domain; and receiving, in response to the transmitting the request, the any one or more configurations included in the request.

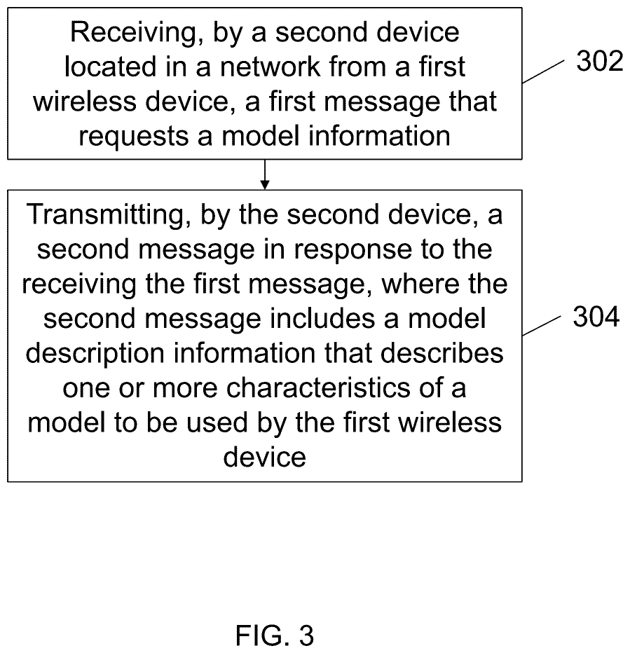

FIG. 3 shows an example flowchart for transmitting a model information. Operation 302 includes receiving, by a second device located in a network from a first wireless device, a first message that requests a model information. Operation 304 includes transmitting, by the second device, a second message in response to the receiving the first message, where the second message includes a model description information that describes one or more characteristics of a model to be used by the first wireless device.

In some embodiments, the model description information includes an identifier of the model. In some embodiments, the first message includes a field that identifies a purpose for requesting the model information. In some embodiments, the first message includes any one or more of the following information: a physical cell identifier (PCI), a transmission and reception point (TRP) identifier, an Absolute Radio Frequency Channel Number (ARFCN), a bandwidth of a cell, a sub-carrier spacing of the cell, a number of beams, directions of each of the number of beam, a number of ports, a time periodicity of a reference signal, a sub-band granularity, a first expected number of time occasions used for an input to the model, a second expected number of time occasions used for an output to the model, and/or a resource mapping pattern in frequency domain. In some embodiments, the method further comprises receiving, by the second device in the network from the first wireless device, a third message that request a model deployment information, wherein the third message includes the identifier of the model; and transmitting, in response to the receiving the third message, a fourth message comprising the model deployment information that includes one or more values corresponding to one or more parameters to be used by the model.

In some embodiments, the second message includes a model deployment information that includes one or more values corresponding to one or more parameters to be used by the model. In some embodiments, the method further comprises transmitting, by the second device, a failure message in response to the receiving the first message, wherein the failure message indicates that the second device in the network does not have the model information. In some embodiments, the first wireless device is a base station. In some embodiments, the first wireless device is a communication device.

### IV. Case 2: UE Side Model

In this case, the UE can be considered a first wireless device, and a second device can be gNB/NG-RAN node or a device that reside in a core network entity.

Case 2-1: UE can Provide Some AI Model Information to gNB/NG-RAN Node

In some embodiments, UE may download AI models from a cloud server. However, gNB has no AI model information of the AI models before being provided with some AI model information from UE.

In some embodiments, the some AI model information only includes some of the AI model description information for corresponding AI models.

In some embodiments, UE is not required to provide AI deployment information to gNB.

In some embodiments, UE can send a request to gNB to require assistance data (the assistance data may be helpful for AI model inference at UE), where the assistance data may include any one or more of the following,
Boresight directions of reference signals when gNB transmits the reference signals
Beam width (e.g., 3 dB beam width) of reference signals when gNB transmits the reference signals

In some embodiments, UE can send a request to gNB to provide preferred configurations (the measurement/assistance data based on the preferred configurations may be used as the AI model input), where the preferred configurations indicated in the request may include any one or more of the following:
Physical cell ID (PCI)
TRP (transmission and reception point) ID
ARFCN (Absolute Radio Frequency Channel Number)
Bandwidth of a cell
Sub-carrier spacing of a cell
Number of beams (e.g., number of CSI-RS resources in a CSI-RS resource set)
Directions of each beam (e.g., the direction can be boresight direction of a beam)
Number of ports (e.g., number of ports for a CSI-RS resource)
Time periodicity of reference signal
Sub-band granularity (e.g., the number of resource blocks included in a sub-band)
Expected number of time occasions used for AI model input (which may be used for beam prediction in time domain or CSI prediction in time domain)
Expected number of time occasions used for AI model output (which may be used for beam prediction in time domain or CSI prediction in time domain)
Resource mapping pattern in frequency domain (e.g., to indicate which resource element will transmit reference signal, which may be used for channel estimation or CSI prediction in frequency domain)
   Case 2-2: Model Control Entity Resides at a gNB/NG-RAN Node

In some embodiments, gNB may transmit the AI model information in a system information message
The system information message may be transmitted by a SIB (system information block) in a broadcast channel.
The system information message may be transmitted to UE in a RRC message when the UE is in RRC connected state.
The system information message may only include AI model description information of the AI model information
   Multiple AI models may be included in system information message, each AI model has its corresponding AI model description information. Each of the AI model may be uniquely identified by an AI model ID.
The system information message may also include the configurations of resources that can be used by UE to request or indicate an AI model information. For example, the base station may store a mapping between a plurality of resources and a plurality of AI models such that when a UE transmits data on one of the resources, the base station can determine an AI model that is being requested for use by the UE based on the resource being used by the UE to transmit the data.
   The resources may be PUCCH resources.
   The resources may be Random Access Channels (RACHs).
   One resource may be at least associated with one AI model.
   UE may send a PUCCH/RACH to request gNB to provide AI model information of the associated AI model.

In some embodiments, gNB may provide assistance data to UE (the assistance data may be helpful for AI model inference at UE), where the assistance data may include any one or more of the following
Boresight directions of reference signals when gNB transmits the reference signals
Beam width (e.g., 3 dB beam width) of reference signals when gNB transmits the reference signals

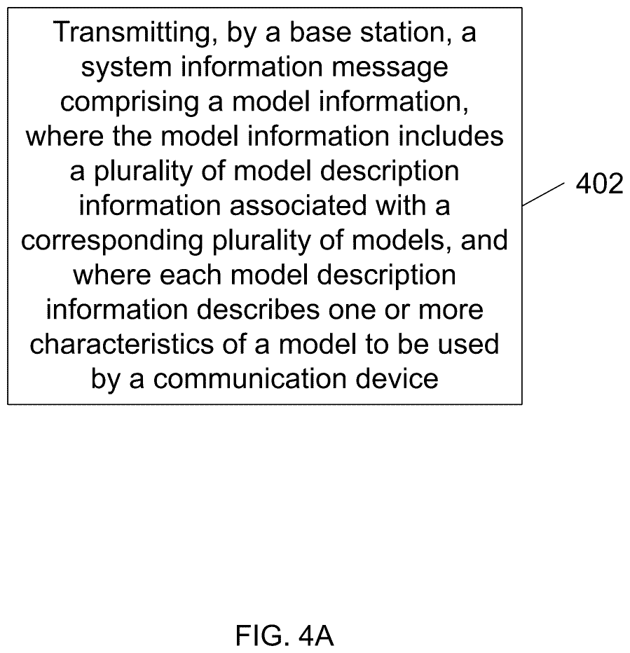

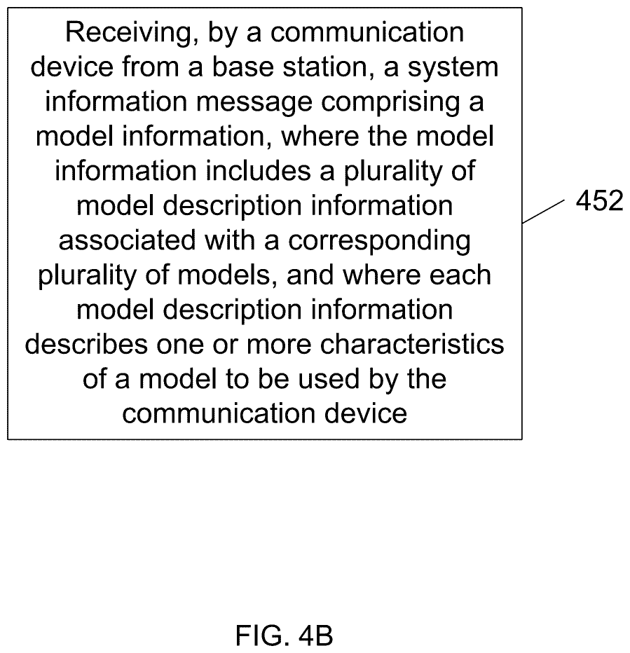

FIG. 4A shows an example flowchart for transmitting a model information. Operation 402 includes transmitting, by a base station, a system information message comprising a model information, where the model information includes a plurality of model description information associated with a corresponding plurality of models, and where each model description information describes one or more characteristics of a model to be used by a communication device.

In some embodiments, one of the plurality of model description information includes at least one identifier of one model. In some embodiments, the system information message is sent in a system information block (SIB), or in a radio resource control (RRC) message when the communication device is in a RRC connected state. In some embodiments, the system information message includes configuration of a plurality of resources to be used by the communication device, and at least one of the plurality of resources are mapped to at least one model from the plurality of models. In some embodiments, the plurality of resources includes a plurality of physical uplink control channel (PUCCH) resources or a plurality of random access channels (RACHs). In some embodiments, the method further comprises transmitting assistance data to the communication device, where the assistance data includes boresight directions of reference signals when the base station transmits the reference signals, and/or beam width of the reference signals when the base station transmits the reference signals.

In some embodiments, the at least one identifier includes any one of: a first identifier related to an encoder of the model, a second identifier related to a decoder of the model, or the first identifier and the second identifier. In some embodiments, the method further comprises receiving, by the base station from the communication device, a message that includes an identifier related to an encoder of the model that is used by the communication device.

FIG. 4B shows an example flowchart for receiving a model information. Operation 452 includes receiving, by a communication device from a base station, a system information message comprising a model information, where the model information includes a plurality of model description information associated with a corresponding plurality of models, and where each model description information describes one or more characteristics of a model to be used by the communication device.

In some embodiments, one of the plurality of model description information includes at least one identifier of one model. In some embodiments, the system information message is received in a system information block (SIB), or in a radio resource control (RRC) message when the communication device is in a RRC connected state. In some embodiments, the system information message includes configuration of a plurality of resources to be used by the communication device, and at least one of the plurality of resources are mapped to at least one model from the plurality of models. In some embodiments, the plurality of resources includes a plurality of physical uplink control channel (PUCCH) resources or a plurality of random access channels (RACHs).

In some embodiments, the method further comprises receiving assistance data, where the assistance data includes boresight directions of reference signals when the base station transmits the reference signals, and/or beam width of the reference signals when the base station transmits the reference signals. In some embodiments, the at least one identifier includes any one of: a first identifier related to an encoder of the model, a second identifier related to a decoder of the model, or the first identifier and the second identifier. In some embodiments, the method further comprises transmitting, by the communication device to the base station, a message that includes an identifier related to an encoder of the model that is used by the communication device.

### Case 2-3: Model Control Entity Resides at a Core Network Entity

Case 2-3-1: AI Model Information is Non-Transparent to gNB/NG-RAN Node

In this case, a UE determines/conducts an AI model inference, and model control entity resides at a core network entity. AI model information is non-transparent to gNB/NG-RAN node, which means that gNB has the both AI model description information and AI model deployment information of AI models.
Transfer of the AI model information between gNB and model control entity, which is similar to the discussions in Case 1 as follows (the difference is that the AI model inference is performed entirely at the UE):
gNB can send a request to the model control entity for AI model information.
   In some embodiments, the request may include information that indicates the purpose of AI model. E.g, for beam prediction, CSI prediction or LoS/NLOS identification
   In some embodiments, the request may further include any one or more of the following information (which can be used for model control entity to decide which AI model is required by gNB)
      Physical cell ID (PCI)
      TRP (transmission and reception point) ID
      ARFCN (Absolute Radio Frequency Channel Number)
      Bandwidth of a cell
      Sub-carrier spacing of a cell
      Number of beams (e.g., number of CSI-RS resources in a CSI-RS resource set)
      Directions of each beam (e.g., the direction can be boresight direction of a beam)
      Number of ports (e.g., number of ports for a CSI-RS resource)
      Time periodicity of reference signal
      Sub-band granularity (e.g., the number of resource blocks included in a sub-band)
      Expected number of time occasions used for AI model input (which may be used for beam prediction in time domain or CSI prediction in time domain)
      Expected number of time occasions used for AI model output (which may be used for beam prediction in time domain or CSI prediction in time domain)
      Resource mapping pattern in frequency domain (e.g., to indicate which resource element will transmit reference signal, which may be used for channel estimation or CSI prediction in frequency domain)
The model control entity sends a response in response to the request from gNB
   The response may indicate the failure to the request (e.g., there is no requested AI model information in model control entity)
   In some embodiments, the response may only include AI model description information of AI models, wherein each AI model maybe uniquely identified by a model ID.
      gNB can may send a request to the model control entity for AI model deployment information of a AI model, wherein the request may include an AI model ID.
   In some embodiments, the response may include both AI model description information and AI deployment information of AI models, wherein each AI model maybe uniquely identified by a model ID.
gNB can may send a request to the model control entity for AI model deployment information of a AI model, wherein the request may include an AI model ID.

Transfer of the AI model information between gNB and UE, which is similar to the discussions in Case 2-2 as follows:
In some embodiments, gNB may transmit the AI model information in a system information message
   The system information message may be transmitted by a SIB (system information block) in a broadcast channel.
   The system information message may be transmitted to UE in a RRC message when the UE is in RRC connected state.
   The system information message may only include AI model description information of the AI model information
      Multiple AI models may be included in system information message, each AI model has its corresponding AI model description information. Each of the AI model may be uniquely identified by an ID.
   The system information message may also include the configurations of resources that can be used by UE to request AI model information:
      The resources may be PUCCH resources
      The resources may be Random Access Channels (RACHs)
      One resource may be at least associated with one AI model
      UE may send a PUCCH/RACH to request gNB to provide AI model deployment information of the associated AI model

In some embodiments, gNB may provide assistance data to UE (the assistance data may be helpful for AI model inference at UE), where the assistance data may include any one or more of the following
Boresight directions of reference signals when gNB transmits the reference signals
Beam width (e.g., 3 dB beam width) of reference signals when gNB transmits the reference signals
   Case 2-3-2: AI Model Information is Transparent to gNB/NG-RAN Node

In this case, a UE determines/conducts an AI model inference, and model control entity resides at a core network entity. gNB has no AI model information of the AI models before being provided with some AI model information from UE.
UE can send a request to the model control entity for AI model information.
   In some embodiments, the request may include the information that indicates purpose of AI model. E.g., for beam prediction, CSI prediction or LoS/NLOS identification
   In some embodiments, the request may further include any one or more of the following information (which can be used for model control entity to decide what kind of AI model is required by UE)
      Physical cell identifier (PCI)
      transmission and reception point identifier (TRP ID)
      Absolute Radio Frequency Channel Number (ARFCN)
      Bandwidth of a cell
      Sub-carrier spacing of a cell
      Number of beams (e.g., number of CSI-RS resources in a CSI-RS resource set)
      Directions of each beam (e.g., the direction can be boresight direction of a beam)
      Number of ports (e.g., number of ports for a CSI-RS resource)
      Time periodicity of reference signal
      Sub-band granularity (e.g., the number of resource blocks included in a sub-band)
      Expected number of time occasions used for AI model input (which may be used for beam prediction in time domain or CSI prediction in time domain)
      Expected number of time occasions used for AI model output (which may be used for beam prediction in time domain or CSI prediction in time domain)
      Resource mapping pattern in frequency domain (e.g., to indicate which resource element will transmit reference signal, which may be used for channel estimation or CSI prediction in frequency domain)
The model control entity sends a response in response to the request from UE
   The response may indicate the failure to the request (e.g., there is no requested AI model information in model control entity)
   In some embodiments, the response may only include AI model description information of AI models, wherein each AI model maybe uniquely identified by as AI model ID.
      UE may send a request to the model control entity for AI model deployment information of a AI model, wherein the request may include an AI model ID.
   In some embodiments, the response may include both AI model description information and AI deployment information of AI models, wherein each AI model maybe uniquely identified by a model ID.
In some embodiments, the request and response are transmitted by NAS (Non-Access Stratum) messages between UE and model control entity
In some embodiments, UE may download AI models from a model control entity. However, gNB has no AI model information of the AI models before being provided with some AI model information from UE, which is similar to case 2-1 as follows:
   In some embodiments, the AI model information only includes some of the AI model description information for corresponding AI models.
   In some embodiments, UE is not required to provide AI deployment information to gNB or the UE determines not to provide the AI deployment information to the gNB.
   In some embodiments, UE can send a request to gNB to acquire assistance data (the assistance data may be helpful for AI model inference at UE), where the assistance data may include any one or more of the following
      Boresight directions of reference signals when gNB transmits the reference signals
      Beam width (e.g., 3 dB beam width) of reference signals when gNB transmits the reference signals
   In some embodiments, UE can send a request to gNB to provide preferred configurations (the measurement/assistance data based on the preferred configurations may be used as the AI model input), where the preferred configurations indicated in the request may include any one or more of the following
      Physical cell ID (PCI)
      TRP (transmission and reception point) ID
      ARFCN (Absolute Radio Frequency Channel Number)
      Bandwidth of a cell
      Sub-carrier spacing of a cell
      Number of beams (e.g., number of CSI-RS resources in a CSI-RS resource set)
      Directions of each beam (e.g., the direction can be boresight direction of a beam)
      Number of ports (e.g., number of ports for a CSI-RS resource)
      Time periodicity of reference signal
      Sub-band granularity (e.g., the number of resource blocks included in a sub-band)
      Expected number of time occasions used for AI model input (which may be used for beam prediction in time domain or CSI prediction in time domain)
      Expected number of time occasions used for AI model output (which may be used for beam prediction in time domain or CSI prediction in time domain)
      Resource mapping pattern in frequency domain (e.g., to indicate which resource element will transmit reference signal, which may be used for channel estimation or CSI prediction in frequency domain)

### Case 2-3-3: Partial AI Model Information is Transparent to gNB (or NG-RAN Node)

In this case, a UE determines/conducts an AI model inference, and model control entity resides at a core network entity. Partial AI model information is transparent to gNB means that gNB has the AI model description information of AI models and gNB has no AI model information of the AI deployment information of AI models.
gNB can send a request to the model control entity for AI model description information.
   In some embodiments, the request may include information that indicates the purpose of AI model. E.g., for beam prediction, CSI prediction or LoS/NLOS identification
   In some embodiments, the request may further include any one or more of the following information (which can be used for model control entity to decide what kind of AI model is required by gNB)
      Physical cell ID (PCI)
      TRP (transmission and reception point) ID
      ARFCN (Absolute Radio Frequency Channel Number)
      Bandwidth of a cell
      Sub-carrier spacing of a cell
      Number of beams (e.g., number of CSI-RS resources in a CSI-RS resource set)
      Directions of each beam (e.g., the direction can be boresight direction of a beam)
      Number of ports (e.g., number of ports for a CSI-RS resource)
      Time periodicity of reference signal
      Sub-band granularity (e.g., the number of resource blocks included in a sub-band)
      Expected number of time occasions used for AI model input (which may be used for beam prediction in time domain or CSI prediction in time domain)
      Expected number of time occasions used for AI model output (which may be used for beam prediction in time domain or CSI prediction in time domain)
      Resource mapping pattern in frequency domain (e.g., to indicate which resource element will transmit reference signal, which may be used for channel estimation or CSI prediction in frequency domain)
The model control entity sends a response in response to the request from gNB
   The response may indicate the failure to the request (e.g., there is no requested AI model in model control entity)
   In some embodiments, the response may only include AI model description information of AI models, wherein each AI model maybe uniquely identified by a model ID.
In some embodiments, UE may obtain the AI model information via one of the following ways:
   gNB may indicate UE to download AI model deployment information from model control entity.
      The indication may include either a model ID or AI model description information of an AI model.
      UE may send a response to gNB that indicates the requested AI model has been obtained by UE.
   gNB may request model control entity to provide AI model deployment information to UE
      The indication may include either a model ID or AI model description information of an AI model.
      The model control entity may send a response to gNB that indicates which AI model has been provided to UE.
   UE may request model control entity to provide AI model information
   In above methods, transfer of the AI model information between model control entity and UE is similar to the discussions in Case 2-3-2 as follows:
      UE can send a request to the model control entity for AI model information.
         In some embodiments, the request may include information that indicates the purpose of AI model. E.g., for beam prediction, CSI prediction or LoS/NLOS identification
         In some embodiments, the request may further include any one or more of the following information (which can be used for model control entity to decide what kind of AI model is required by UE)
         Physical cell ID (PCI)
         TRP (transmission and reception point) ID
         ARFCN (Absolute Radio Frequency Channel Number)
         Bandwidth of a cell
         Sub-carrier spacing of a cell
         Number of beams (e.g., number of CSI-RS resources in a CSI-RS resource set)
         Directions of each beam (e.g., the direction can be boresight direction of a beam)
         Number of ports (e.g., number of ports for a CSI-RS resource)
         Time periodicity of reference signal
         Sub-band granularity (e.g., the number of resource blocks included in a sub-band)
         Expected number of time occasions used for AI model input (which may be used for beam prediction in time domain or CSI prediction in time domain)
         Expected number of time occasions used for AI model output (which may be used for beam prediction in time domain or CSI prediction in time domain)
         Resource mapping pattern in frequency domain (e.g., to indicate which resource element will transmit reference signal, which may be used for channel estimation or CSI prediction in frequency domain)
      The model control entity sends a response in response to the request from UE
         The response may indicate the failure to the request (e.g., there is no requested AI model information in model control entity)
         The response may only include AI model description information of AI models, wherein each AI model maybe uniquely identified by an AI model ID.
         In some embodiments, the response may only include AI model description information of AI models, wherein each AI model maybe uniquely identified by a model ID.
         UE can may send a request to the model control entity for AI model deployment information of an AI model, wherein the request may include an AI model ID.
         In some embodiments, the response may include both AI model description information and AI deployment information of AI models, wherein each AI model maybe uniquely identified by an AI model ID.
      In some embodiments, the request and response are transmitted by NAS (Non-Access Stratum) messages between UE and model control entity
   In some embodiments, gNB may provide assistance data to UE (the assistance data may be helpful for AI model inference at UE), where the assistance data may include any one or more of the following
Boresight directions of reference signals when gNB transmits the reference signals
Beam width (e.g., 3 dB beam width) of reference signals when gNB transmits the reference signals

### V. Case 3: Two Side Model

Case 3-1: UE can Provide Some AI Model Information to gNB/NG-RAN Node

In some embodiments, UE may download encoder part of AI models from a cloud server. However, gNB has no AI model information of the AI models before being provided with some AI model information from UE.

In some embodiments, the some AI model information only includes some of the AI model description information for corresponding to the encoder part of AI models, where each encoder part maybe uniquely identified by an ID. In some embodiments, UE is not required to provide AI deployment information to gNB.

In some embodiments, UE can send a request to gNB to require assistance data (the assistance data may be helpful for AI model inference at UE), where the assistance data may include any one or more of the following:
Boresight directions of reference signals when gNB transmits the reference signals
Beam width (e.g., 3 dB beam width) of reference signals when gNB transmits the reference signals

In some embodiments, UE can send a request to gNB to provide preferred configurations (the measurements based on the preferred configurations may be used as the AI model input), where the preferred configurations indicated in the request may include any one or more of the following
Physical cell ID (PCI)
TRP (transmission and reception point) ID
ARFCN (Absolute Radio Frequency Channel Number)
Cell bandwidth and sub-carrier spacing
Number of beams (e.g., number of CSI-RS resources in a CSI-RS resource set)
Directions of each beam (e.g., the direction can be boresight direction of a beam)
Number of ports (e.g., number of ports for a CSI-RS resource)
Time periodicity of reference signal
Sub-band granularity (e.g., the number of resource blocks included in a sub-band)
Expected number of time occasions used for AI model input (which may be used for beam prediction in time domain or CSI prediction in time domain)
Expected number of time occasions used for AI model output (which may be used for beam prediction in time domain or CSI prediction in time domain)
Resource mapping pattern in frequency domain (e.g., to indicate which resource element will transmit reference signal, which may be used for channel estimation or CSI prediction in frequency domain)

In some embodiments, gNB may indicate which AI model (or encoder part) shall be used for AI model inference at UE, where the indication may include at least an AI model ID to the encoder part.

Case 3-2: gNB/NG-RAN Node can Provide Some AI Model Information to UE

In some embodiments, gNB may transmit the AI model information in a system information message
The system information message may be transmitted by a SIB (system information block) in a broadcast channel.
The system information message may be transmitted to UE in a RRC message when the UE is in RRC connected state.
The system information message may only include AI model description information of the AI model information
   Multiple AI models may be included in system information message, each AI model has its corresponding AI model description information. Each of the AI model may be uniquely identified by an AI model ID. In some embodiments, the AI model ID can be one of the following,
      An encoder part ID
      A decoder part ID
      A pair of {encoder part ID, decoder part ID}

In some embodiments, the system information message may also include the configurations of resources that can be used by UE to request AI model information
The resources may be PUCCH resources
The resources may be Random Access Channels (RACHs)
One resource may be at least associated with one AI model
UE may send a PUCCH/RACH to request gNB to provide AI model information of encoder part of the AI model

In some embodiments, UE may inform gNB which encoder part (e.g., via an encoder part ID) has been used for AI model inference.

### Case 3-3: Model Control Entity Resides at a Core Network Entity

If there are no conflicts, the transfer of AI model information related to decoder part of AI model that happens between model control entity and gNB can reuse the procedures in Case 1 for network side model.

If there are no conflicts, the transfer of AI model information related to encoder part of AI model that happens between model control entity and gNB or between model control entity and UE can reuse the procedures in Case 2-3 for UE side model.

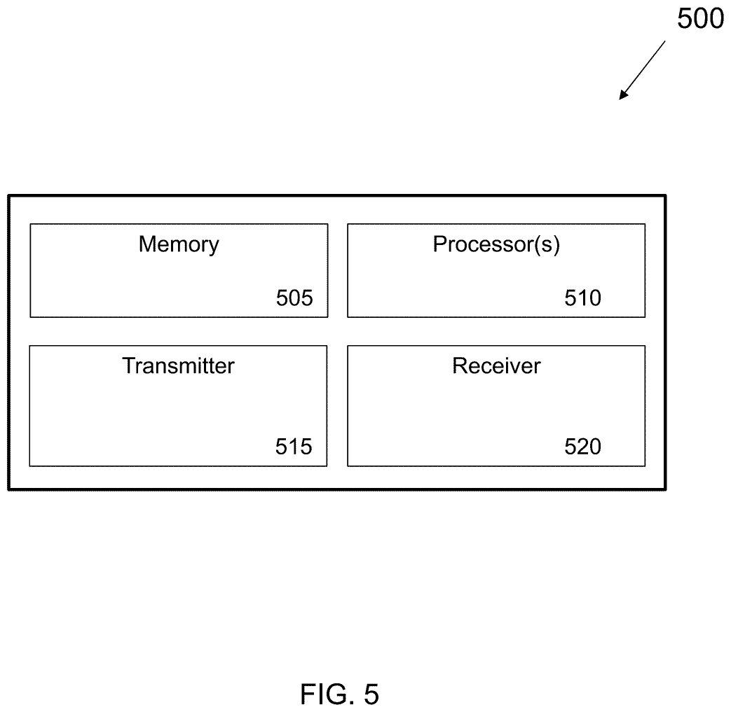

FIG. 5 shows an exemplary block diagram of a hardware platform 500 that may be a part of a network device (e.g., base station) or a communication device (e.g., a user equipment (UE)). The hardware platform 500 includes at least one processor 510 and a memory 505 having instructions stored thereupon. The instructions upon execution by the processor 510 configure the hardware platform 500 to perform the operations described in FIGS. 1 to 4B and in the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device.

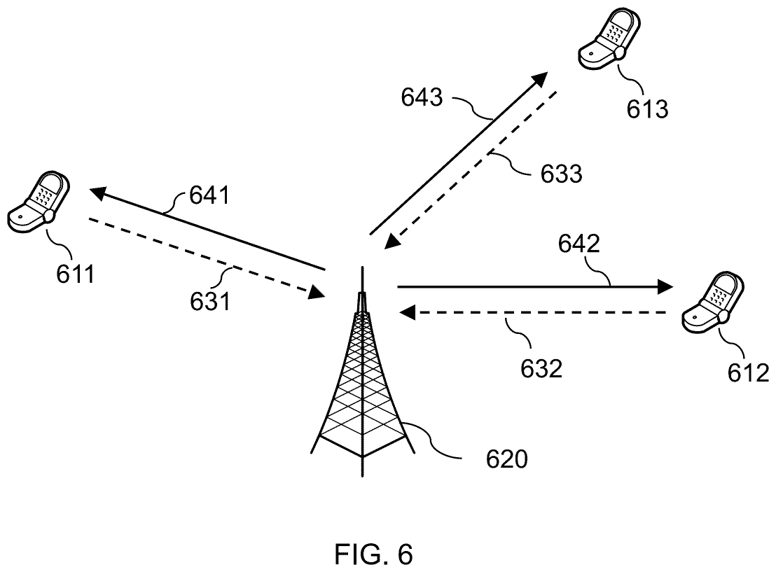

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IoT) device, and so on.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A wireless communication method, comprising:
transmitting, by a first wireless device to a second device located in a network, a first message that requests a model information; and
receiving, by the first wireless device, a second message in response to the transmitting the first message,
wherein the second message includes a model description information that describes one or more characteristics of a model to be used by the first wireless device.

2. The method of claim 1, wherein the model description information includes an identifier of the model.

3. The method of claim 1, wherein the first message includes a field that identifies a purpose for requesting the model information.

4. The method of claim 1, further comprising:
transmitting, by the first wireless device to the second device in the network, a third message that request a model deployment information, wherein the third message includes the identifier of the model; and
receiving, in response to the transmitting the third message, a fourth message comprising the model deployment information that includes one or more values corresponding to one or more parameters to be used by the model.

5. The method of claim 1, wherein the second message includes a model deployment information that includes one or more values corresponding to one or more parameters to be used by the model.

6. The method of claim 1, further comprising:
receiving, by the first wireless device, a failure message in response to the transmitting the first message, wherein the failure message indicates that the second device in the network does not have the model information.

7. A wireless communication method, comprising:
receiving, by a second device located in a network from a first wireless device, a first message that requests a model information; and
transmitting, by the second device, a second message in response to the receiving the first message,
wherein the second message includes a model description information that describes one or more characteristics of a model to be used by the first wireless device.

8. The method of claim 7, wherein the model description information includes an identifier of the model.

9. The method of claim 7, wherein the first message includes a field that identifies a purpose for requesting the model information.

10. The method of claim 7, further comprising:
receiving, by the second device in the network from the first wireless device, a third message that request a model deployment information, wherein the third message includes the identifier of the model; and
transmitting, in response to the receiving the third message, a fourth message comprising the model deployment information that includes one or more values corresponding to one or more parameters to be used by the model.

11. The method of claim 7, wherein the second message includes a model deployment information that includes one or more values corresponding to one or more parameters to be used by the model.

12. The method of claim 7, further comprising:
transmitting, by the second device, a failure message in response to the receiving the first message, wherein the failure message indicates that the second device in the network does not have the model information.

13. A first wireless device for wireless communication, comprising a processor configured to implement a method, the processor configures the first wireless device to:
transmit, by a first wireless device to a second device located in a network, a first message that requests a model information; and
receive by the first wireless device, a second message in response to the transmit the first message,
wherein the second message includes a model description information that describes one or more characteristics of a model to be used by the first wireless device.

14. The first wireless device of claim 13, wherein the model description information includes an identifier of the model.

15. The first wireless device of claim 13, wherein the first message includes a field that identifies a purpose for requesting the model information.

16. The first wireless device of claim 13, wherein the processor further configures the first wireless device to:
transmit, by the first wireless device to the second device in the network, a third message that request a model deployment information, wherein the third message includes the identifier of the model; and
receive, in response to the transmit the third message, a fourth message comprising the model deployment information that includes one or more values corresponding to one or more parameters to be used by the model.

17. An second device for wireless communication, comprising a processor configured to implement a method, the processor configures the second device to:
receive, by a second device located in a network from a first wireless device, a first message that requests a model information; and
transmit, by the second device, a second message in response to the receive the first message,
wherein the second message includes a model description information that describes one or more characteristics of a model to be used by the first wireless device.

18. The second device of claim 17, wherein the model description information includes an identifier of the model.

19. The second device of claim 17, wherein the first message includes a field that identifies a purpose for requesting the model information.

20. The second device of claim 17, wherein the processor further configures the second device to:
receive, by the second device in the network from the first wireless device, a third message that request a model deployment information, wherein the third message includes the identifier of the model; and
transmit, in response to the receive the third message, a fourth message comprising the model deployment information that includes one or more values corresponding to one or more parameters to be used by the model.
